(19) United States
(12) Patent Application Publication
(10) Pub. No.: US 2015/0156207 A1
(43) Pub. Date: Jun. 4, 2015

(54) NETWORK SERVICE SYSTEM AND NETWORK SERVICE UTILIZING METHOD THEREOF

(71) Applicant: Institute For Information Industry, Taipei (TW)

(72) Inventors: Jay UNGER, Darnestown, MD (US); Phoenix LEE, New Taipei City (TW); Yen-Hung KUO, Taipei City (TW); Yu-Lin JENG, Tainan City (TW)

(73) Assignee: Institute For Information Industry, Taipei (TW)

(21) Appl. No.: 14/094,458

(22) Filed: Dec. 2, 2013

(51) Int. Cl. H04L 29/06

(52) U.S. Cl. CPC H04L 63/12; H04L 63/061

(57) ABSTRACT

A network service system and a network service utilizing method thereof are provided. The network service system includes a network service providing apparatus and a network service using apparatus. The network service providing apparatus provides a machine-readable code. The network service using apparatus parses the machine-readable code to obtain an identification and a key. The network service providing apparatus transmits an encrypted message to the network service using apparatus based on the identification. The network service using apparatus decrypts the encrypted message into service information by the key and uses a service of the network service providing apparatus after connecting to the network service providing apparatus according to the service information.

### FIELD

The present invention relates to a network service system and a network service utilizing method thereof; and more particularly, the network service system and the network service utilizing method thereof according to the present invention are used for quickly connecting to a private network by using a secure manner.

### BACKGROUND

In a conventional private network, when a user device requires a service of a service device, the user needs to input necessary configuration information of the service device to the user device for connecting with the service device first. However, it is very inconvenient for the users who are not familiar with the configuration of the service in the private network. Moreover, if there are similar service devices available in the same private network, the difficulties of configuring a specific service of a specific service device among the service devices will be increased.

Further, some service devices multicast messages in the private network for facilitating configuration, and the messages are usually formatted in plaintext (i.e., un-encrypted). Therefore, in the private network, the messages between the service devices and the user devices are insecure, which may create security loophole of these service devices.

According to the above descriptions, a more convenient and secured service connection method for the private network is in an urgent need.

### SUMMARY

A primary objective of certain embodiments of the invention is to provide a network service utilizing method for use in a network service system. The network service system comprises a network service providing apparatus and a network service using apparatus. The network service utilizing method comprises: (a) enabling the network service providing apparatus to provide a machine-readable code to the network service using apparatus; (b) enabling the network service using apparatus to parse the machine-readable code to obtain an identification of the network service providing apparatus and a key; (c) enabling the network service providing apparatus to transmit an encrypted message to the network service using apparatus based on the identification; (d) enabling the network service using apparatus to decrypt the encrypted message into service information by the key; (e) enabling the network service using apparatus to connect with the network service providing apparatus according to the service information; (f) enabling the network service using apparatus to use a service of the network service providing apparatus.

Another objective of certain embodiments of the invention is to provide a network service system. The network system comprises a network service providing apparatus and a network service using apparatus. The network service providing apparatus provides a machine-readable code to the network service using apparatus. The network service using apparatus parses the machine-readable code to obtain an identification of the network service providing apparatus and a key. The network service providing apparatus further transmits an encrypted message to the network service using apparatus based on the identification. The network service using apparatus further decrypts the encrypted message into service information by the key, connects with the network service providing apparatus according to the service information, and uses a service of the network service providing apparatus.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a network service system according to the first embodiment of the present invention;

FIG. 1B is a block diagram of a network service providing apparatus according to the first embodiment of the present invention;

FIG. 1C is a block diagram of a network service using apparatus according to the first embodiment of the present invention;

FIG. 2A is a schematic view of a network service system according to the second embodiment of the present invention;

FIG. 2B is a block diagram of a network service providing apparatus according to the second embodiment of the present invention;

FIG. 2C is a block diagram of a network service using apparatus according to the second embodiment of the present invention;

FIG. 3 is flowchart diagram of a network service utilizing method according to the third embodiment of the present invention; and

FIG. 4 is flowchart diagram of a network service utilizing method according to the fourth embodiment of the present invention.

### DETAILED DESCRIPTION

The present invention may be explained with reference to the following example embodiments thereof. However, these example embodiments are not intended to limit the present invention to any specific examples, embodiments, environments, applications or implementations described in these embodiments. Therefore, description of these example embodiments is only for purpose of illustration rather than to limit the present invention. In the following embodiments and the attached drawings, elements not directly related to the present invention are omitted from depiction; and dimensional relationships among individual elements in the attached drawings are illustrated only for ease of understanding but not to limit the actual scale.

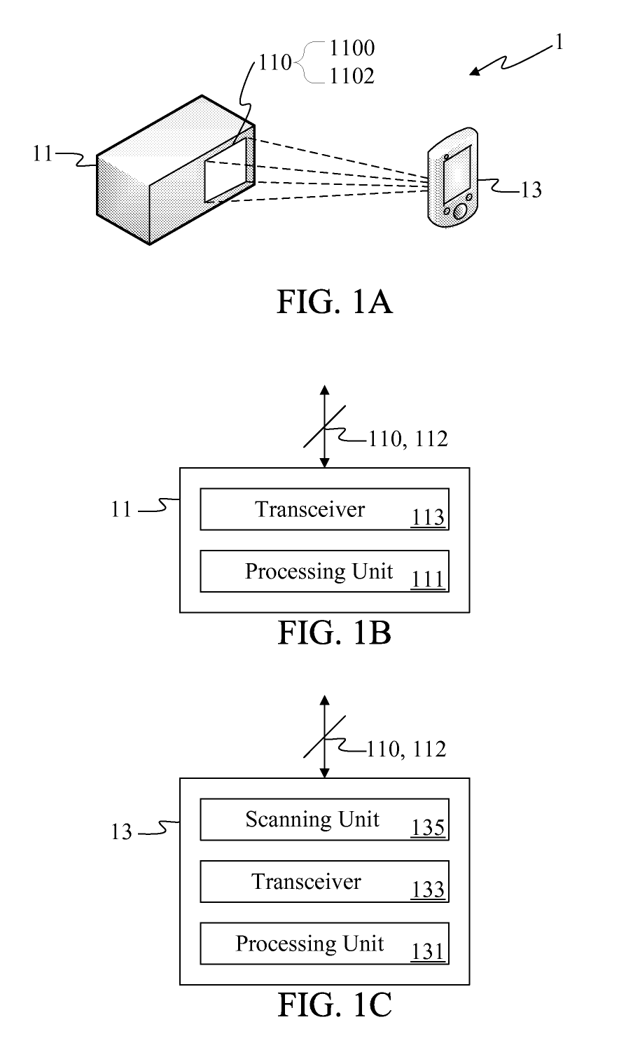

Refer to FIG. 1A to FIG. 1C. FIG. 1A is a schematic view of a network service system 1 according to the first embodiment. The network service system 1 comprises a network service providing apparatus 11 and a network service using apparatus 13. FIG. 1B is a block diagram of the network service providing apparatus 11. FIG. 1C is a block diagram of the network service using apparatus 13. In the first embodiment, the network service providing apparatus 11 comprises a processing unit 111 and a transceiver 113, and the network service using apparatus 13 comprises a processing unit 131, a transceiver 133 and a scanning unit 135. Interactions between the hardware components will be further elucidated hereinbelow.

Firstly, the processing unit 111 of the network service providing apparatus 11 provides a machine-readable code 110 in many possible ways, e.g., generating the machine-readable code and printing out it on a sheet, generating the machine-readable code and displaying it on a remote screen, and so on. Therefore, any device that needs to use the services of the network service providing apparatus 11 can retrieve related information of the network service providing apparatus 11 by parsing the machine-readable code 110. Specifically, after the scanning unit 135 of the network service using apparatus 13 retrieving the machine-readable code 110, the processing unit 131 of the network service using apparatus 13 parses the machine-readable code 110 to obtain an identification 1100 of the network service providing apparatus 11 and a key 1102.

Accordingly, in the private network environment of the first embodiment, when the network service providing apparatus 11 multicasts a message based on the identification 1100, the network service using apparatus 13 then receives and uses the message for connecting to the network service providing apparatus 11. Particularly, the transceiver 113 of the network service providing apparatus 11 transmits an encrypted message 112 to the network service using apparatus 13 based on the identification 1100. Therefore, the transceiver 133 of the network service using apparatus 13 receives the encrypted message 112 based on the identification 1100, and then the processing unit 131 of the network service using apparatus 13 decrypts the encrypted message 112 into service information (not shown) by the key 1102.

Afterwards, since the service information relates to connecting configuration (service address, temporary credential, etc.) of the network service providing apparatus 11, the processing unit 131 of the network service using apparatus 13 is capable of connecting to the network service providing apparatus 11 automatically via the transceiver 133 according to the service information. Then, when the processing unit 111 of the network service providing apparatus 11 provides a service (not shown) to the network service using apparatus 13 via the transceiver 113, the processing unit 131 of the network service using apparatus 13 is further capable of using the service via the transceiver 133.

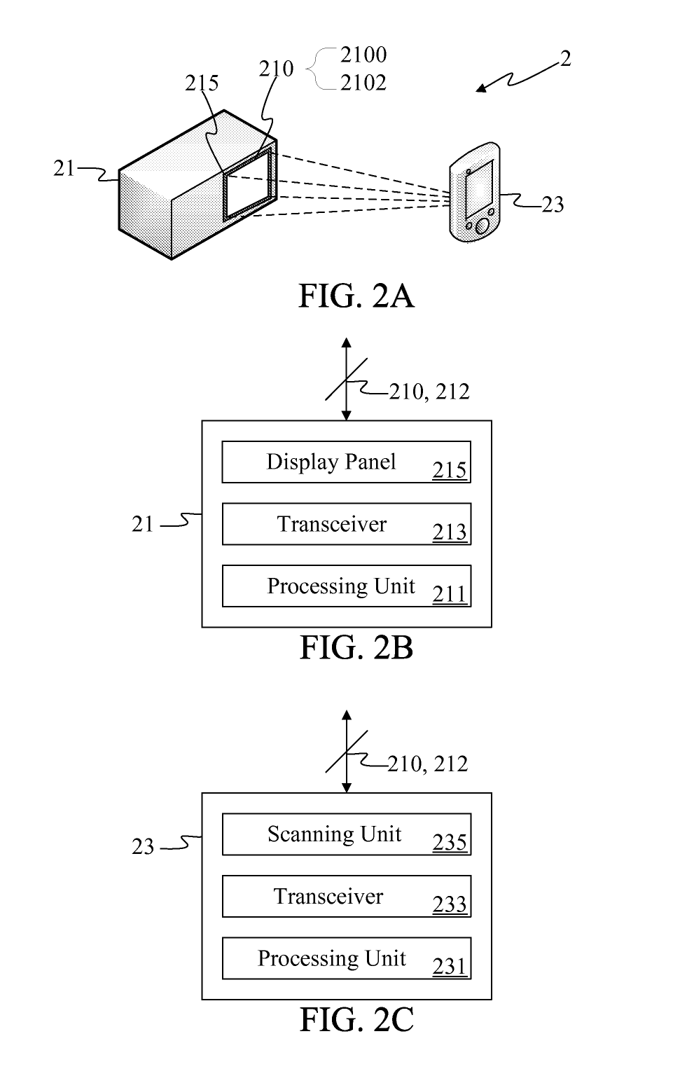

Please refer to FIG. 2A to FIG. 2C. FIG. 2A is a schematic view of a network service system 2 according to a second embodiment. The network service system 2 comprises a network service providing apparatus 21 and a network service using apparatus 23. FIG. 2B is a block diagram of the network service providing apparatus 21. FIG. 2C is a block diagram of the network service using apparatus 23. In the second embodiment, the network service providing apparatus 21 comprises a processing unit 211, a transceiver 213 and a display panel 215, and the network service using apparatus 23 comprises a processing unit 231, a transceiver 233 and a scanning unit 235 (for example, a camera). The second embodiment gives more implemented details of the present invention.

Before providing any information, the processing unit 211 of the network service providing apparatus 21 is capable of generating a machine-readable code 210 based on an identification 2100 of the network service providing apparatus 21 and further a key 2102. Then, the processing unit 211 of the network service providing apparatus 21 provides the machine-readable code 210 via the display panel 215. It should be noted that, in the second embodiment, the machine-readable code 210 could a quick response code (QR code) which is used for transforming texts in a specific pattern. However, it is not intended to limit the implementation of the machine-readable code of the present invention.

Accordingly, any device that needs to use the services of the network service providing apparatus 21 can retrieve related information of the network service providing apparatus 21 by parsing the machine-readable code 210. Specifically, the scanning unit 235 of the network service using apparatus 23 retrieves the machine-readable code 210 shown on the display panel 215 of the network service providing apparatus 21, and then the processing unit 231 of the network service using apparatus 23 parses the machine-readable code 210 to obtain the identification 2100 of the network service providing apparatus 21 and the key 2102.

Next, in the private network environment of the second embodiment, when the network service providing apparatus 21 multicasts an encrypted message based on the identification 2100, the network service using apparatus 23 then receives the encrypted message and decrypts it by using the key for necessary information. Specifically, the transceiver 213 of the network service providing apparatus 21 transmits an encrypted message 212 to the network service using apparatus 23 based on the identification 2100. Therefore, the transceiver 233 receives the encrypted message 212 based on the identification 2100, and then the processing unit 231 of the network service using apparatus 23 decrypts the encrypted message 212 into service information (not shown) of the network service providing apparatus 21 by the key 2102.

Afterwards, since the service information relates to connection configuration (service address, temporary credential, etc.) of the network service providing apparatus 21, the processing unit 231 of the network service using apparatus 23 is capable of connecting to the network service providing apparatus 21 automatically via the transceiver 233 according to the service information of the encrypted message 212. Then, when the processing unit 211 of the network service providing apparatus 21 provides a service (not shown) to the network service using apparatus 23 via the transceiver 213, the processing unit 231 of the network service using apparatus 23 is further capable of using the service via the transceiver 233.

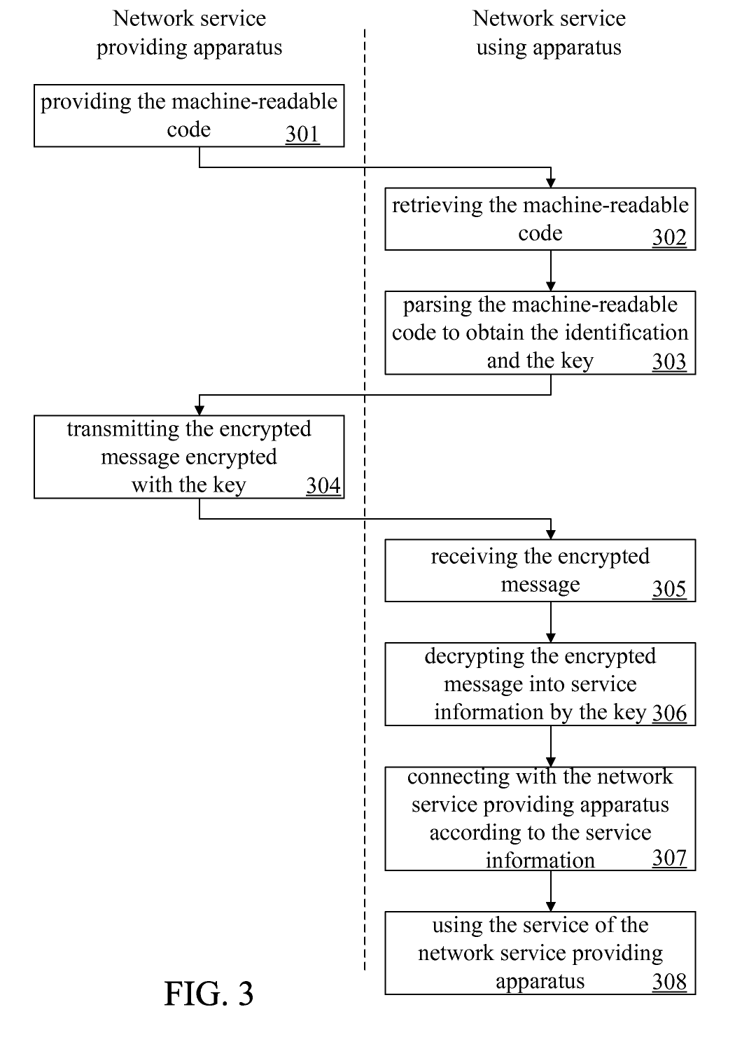

Referring to FIG. 3, there is shown a flowchart diagram of a network service utilizing method according to a third embodiment of the present invention. The network service utilizing method of the third embodiment is for use in a network service system (e.g., the network service system of the first embodiment). The network service system comprises a network service providing apparatus and a network service using apparatus (e.g., the network service providing apparatus and the network service using apparatus of the first embodiment). Steps of the network service utilizing method of the third embodiment will be detailed as follows.

Firstly, step 301 is executed to enable the network service providing apparatus to provide a machine-readable code to the network service using apparatus. Then, step 302 is executed to enable the network service using apparatus to retrieve the machine-readable code. Then, step 303 is executed to enable the network service using apparatus to parse the machine-readable code to obtain an identification of the network service providing apparatus and a key.

Next, step 304 is executed to enable the network service providing apparatus to transmit an encrypted message to the network service using apparatus based on the identification. Step 305 is executed to enable the network service using apparatus to receive the encrypted message. Step 306 is executed to enable the network service using apparatus to decrypt the encrypted message into service information by the key.

Step 307 is executed to enable the network service using apparatus to connect with the network service providing apparatus according to the service information. Finally, step 308 is executed to enable the network service using apparatus to use a service of the network service providing apparatus.

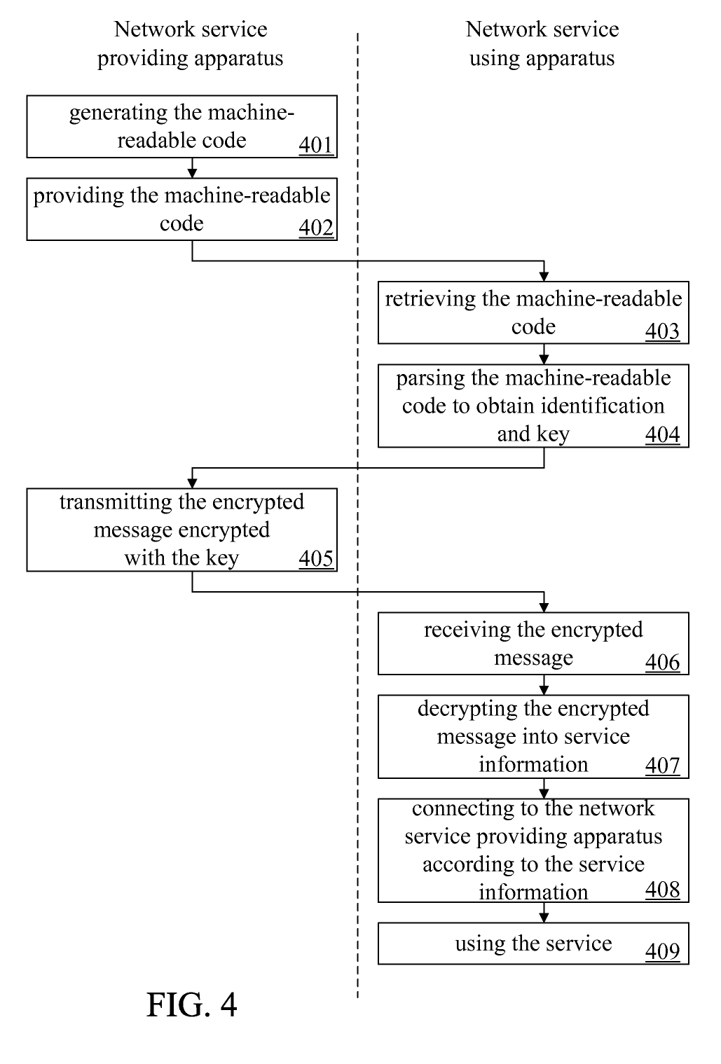

Referring to FIG. 4, there is shown a flowchart diagram of a network service utilizing method according to a fourth embodiment of the present invention. The network service utilizing method of the fourth embodiment is for use in a network service system (e.g., the network service system of the second embodiment). The network service system comprises a network service providing apparatus and a network service using apparatus (e.g., the network service providing apparatus and the network service using apparatus of the second embodiment). Steps of the network service utilizing method of the fourth embodiment will be detailed as follows.

Firstly, step 401 is executed to enable the network service providing apparatus to generate a machine-readable code based on an identification of the network service providing apparatus and further a key. Step 402 is executed to enable the network service providing apparatus to provide the machine-readable code to the network service using apparatus. Then, step 403 is executed to enable the network service using apparatus to retrieve the machine-readable code from the network service providing apparatus. Step 404 is executed to enable the network service using apparatus to parse the machine-readable code to obtain the identification of the network service providing apparatus and the key.

Therefore, when the network service providing apparatus multicasts an encrypted message based on the identification, the network service using apparatus then receives the encrypted message and decrypts it by using the key for necessary information. Step 405 is executed to enable the network service providing apparatus to transmit an encrypted message encrypted by the key to the network service using apparatus based on the identification. Then, step 406 is executed to enable the network service using apparatus to receive the encrypted message from the network service providing apparatus based on the identification.

Afterwards, step 407 is executed to enable the network service using apparatus to decrypt the encrypted message into service information by the key. Accordingly, step 408 is executed to enable the network service using apparatus to connect to the network service providing apparatus according to the service information of the encrypted message. Finally, step 409 is executed enable the network service using apparatus to use a service of the network service providing apparatus.

According to the above descriptions of the network service system and the network service utilizing method thereof of the present invention, the network service using apparatus can configure the setting only by scanning the machine-readable code provided by the network service providing apparatus, and receive information from the network service providing apparatus securely. Accordingly, the defects of inconvenience and insecure transmission existed in the prior art can be solved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A network service utilizing method for use in a network service system, the network service system comprising a network service providing apparatus and a network service using apparatus, the network service utilizing method comprising:
(a) enabling the network service providing apparatus to provide a machine-readable code to the network service using apparatus;
(b) enabling the network service using apparatus to parse the machine-readable code to obtain an identification of the network service providing apparatus and a key;
(c) enabling the network service providing apparatus to transmit an encrypted message to the network service using apparatus based on the identification;
(d) enabling the network service using apparatus to decrypt the encrypted message into service information by the key;
(e) enabling the network service using apparatus to connect with the network service providing apparatus according to the service information;
(f) enabling the network service using apparatus to use a service of the network service providing apparatus.

2. The network service utilizing method as claimed in claim 1, further comprising following step before step (a):
enabling the network service providing apparatus to generate the machine-readable code based on the identification of the network service providing apparatus and the key.

3. The network service utilizing method as claimed in claim 1, wherein the machine-readable code is a quick response code.

4. A network service system, comprising;
a network service providing apparatus; and
a network service using apparatus;
wherein the network service providing apparatus provides a machine-readable code to the network service using apparatus, the network service using apparatus parses the machine-readable code to obtain an identification of the network service providing apparatus and a key, the network service providing apparatus further transmits an encrypted message to the network service using apparatus based on the identification, and the network service using apparatus further decrypts the encrypted message into service information by the key, connects with the network service providing apparatus according to the service information, and uses a service of the network service providing apparatus.

5. The network service system as claimed in claim 4, wherein the network service providing apparatus further generates the machine-readable code based on the identification of the network service providing apparatus and the key.

6. The network service system as claimed in claim 4, wherein the machine-readable code is a quick response code.

7. A network service utilizing method for use in a network service providing apparatus, the network service providing apparatus being used in a network service system, the network service system further comprising a network service using apparatus, the network service utilizing method comprising:
(a) enabling the network service providing apparatus to provide a machine-readable code to the network service using apparatus so that the network service using apparatus parses the machine-readable code to obtain an identification of the network service providing apparatus and a key;
(b) enabling the network service providing apparatus to transmit an encrypted message to the network service using apparatus based on the identification so that the network service using apparatus receives the encrypted message based on the identification and decrypts the encrypted message into service information of the network service providing apparatus by the key;
(c) enabling the network service providing apparatus to provide a service to the network service using apparatus after the network service using apparatus connects to the network service providing apparatus according to the service information.

8. The network service utilizing method as claimed in claim 7, further comprising following step before step (a):
enabling the network service providing apparatus to generate the machine-readable code based on the identification of the network service providing apparatus and the key.

9. The network service utilizing method as claimed in claim 11, wherein the machine-readable code is a quick response code.

10. A network service providing apparatus for use in a network service system, the network service system further comprising a network service using apparatus, the network service providing apparatus comprising:
a processing unit, being configured to provide a machine-readable code to the network service using apparatus so that the network service using apparatus parses the machine-readable code to obtain an identification of the network service providing apparatus and a key;
a transceiver, being configured to transmit an encrypted message to the network service using apparatus based on the identification so that the network service using apparatus receives the encrypted message based on the identification and decrypts the encrypted message into service information of the network service providing apparatus by the key;
wherein the processing unit is further configured to provide a service to the network service using apparatus via the transceiver after the network service using apparatus connects to the network service providing apparatus according to the service information.

11. The network service providing apparatus as claimed in claim 10, wherein the processing unit is further configured to generate the machine-readable code based on the identification of the network service providing apparatus and the key.

12. The network service providing apparatus as claimed in claim 10, further comprising:
a display panel;
wherein the processing unit is configured to provide the machine-readable code to the network service using apparatus via the display panel.

13. The network service providing apparatus as claimed in claim 10, wherein the machine-readable code is a quick response code.

14. A network service utilizing method for use in a network service using apparatus, the network service using apparatus being used in a network service system, the network service system further comprising a network service providing apparatus, the network service utilizing method comprising:
(a) enabling the network service using apparatus to retrieve a machine-readable code provided by the network service using apparatus;
(b) enabling the network service using apparatus to parse the machine-readable code to obtain an identification of the network service providing apparatus and a key;
(c) enabling the network service using apparatus to receive an encrypted message from the network service providing apparatus based on the identification;
(d) enabling the network service using apparatus to decrypt the encrypted message into service information of the network service providing apparatus by the key;
(e) enabling the network service using apparatus to connect with the network service providing apparatus according to the service information;
(e) enabling the network service using apparatus to use a service of the network service providing apparatus.

15. The network service utilizing method as claimed in claim 14, wherein the machine-readable code is a quick response code.

16. A network service using apparatus for use in a network service system, the network service system further comprising a network service providing apparatus, the network service using apparatus comprising:
a scanning unit, being configured to retrieve machine-readable code provided by the network service using apparatus;
a processing unit, being configured to parse the machine-readable code to obtain an identification of the network service providing apparatus and a key;
a transceiver, being configured to receive an encrypted message from the network service providing apparatus based on the identification;
wherein the processing unit is further configured to decrypt the encrypted message into service information of the network service providing apparatus by the key, connect with the network service providing apparatus according to the service information via the transceiver, and use a service of the network service providing apparatus via the transceiver.

17. The network service using apparatus as claimed in claim 16, wherein the scanning unit is a camera.

18. The network service using apparatus as claimed in claim 16, wherein the machine-readable code is a quick response code.
